(19) United States
(12) Patent Application Publication
(10) Pub. No.: US 2025/0371031 A1
(43) Pub. Date: Dec. 4, 2025

(54) LOGICAL CLONE REPLICATION

(71) Applicant: Snowflake Inc., Bozeman, MT (US)

(72) Inventors: Chong Han, Bellevue, WA (US); Nithin Mahesh, Redmond, WA (US); Krishna B. Nibhanupudi, Shoreline, WA (US); Siddarth Ramadoss, Kirkland, WA (US); Rakshit Wadhwa, Botthell, WA (US); Yizhi Zhu, Bellevue, WA (US)

(21) Appl. No.: 18/790,979

(22) Filed: Jul. 31, 2024

Related U.S. Application Data
(60) Provisional application No. 63/653,463, filed on May 30, 2024.

(51) Int. Cl. G06F 16/27; G06F 16/11; G06F 16/174

(52) U.S. Cl. CPC G06F 16/278; G06F 16/128; G06F 16/1756

(57) ABSTRACT

Data replication can be used to copy database data from a primary deployment to a secondary deployment in a network-based data system. Logical representation of the clone tables in the secondary deployment can be used to reduce data transfer and storage costs. In response to a refresh request, the data system may clone from existing tables stored in the secondary deployment by applying a difference operation on the existing tables instead of copying entire cloned tables for each refresh request.

### CROSS-REFERENCE TO RELATED APPLICATION

This application claims the benefit of priority to U.S. Provisional Patent Application Ser. No. 63/653,463 filed May 30, 2024, entitled “LOGICAL CLONE REPLICATION,” the contents of which are incorporated herein by reference in its entirety.

### TECHNICAL FIELD

The present disclosure generally relates to data systems, and, more specifically, replicating and cloning data objects, such as tables.

### BACKGROUND

As the world becomes more data driven, database systems and other data systems are storing more and more data. Some tables can include thousands and even hundreds of thousands of columns. In some systems, users may create replicated data objects, such as tables, for disaster recovery or other scenarios. However, replicating entire databases can significantly increase storage costs.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a schematic diagram of a data structure for storage of database metadata, according to some example embodiments.

FIG. 5 is a schematic diagram of a data structure for storage of database metadata, according to some example embodiments.

FIG. 6 is a flow diagram of method for replicating cloned tables in a network-based data system, according to some example embodiments.

FIG. 7 shows an example of clone replication, according to some example embodiments.

FIGS. 8A-8C show another example of clone replication, according to some example embodiments.

FIGS. 9A-9B show another example of clone replication, according to some example embodiments.

FIG. 10 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein are techniques for replicating databases in a network-based data system using logical clone replication. Users may store data in respective primary deployments in the network-based data system. Users may backup the data in respective secondary deployments. In some examples, the secondary deployment may be provided in a different geographical region, different cloud service provider, etc. The techniques described herein use logical representation of cloned tables instead of physically copying each table in the secondary deployment.

Logical representation of the clone tables in the secondary deployment can be used to reduce data transfer and storage costs. In response to a refresh request, the data system may clone from existing tables stored in the secondary deployment by applying a difference operation on the existing tables instead of copying entire cloned tables for each refresh request. Partition files (files including data in micro-partitions) can be further deduped in the replication process to further reduce usage of data transfer and storage resources.

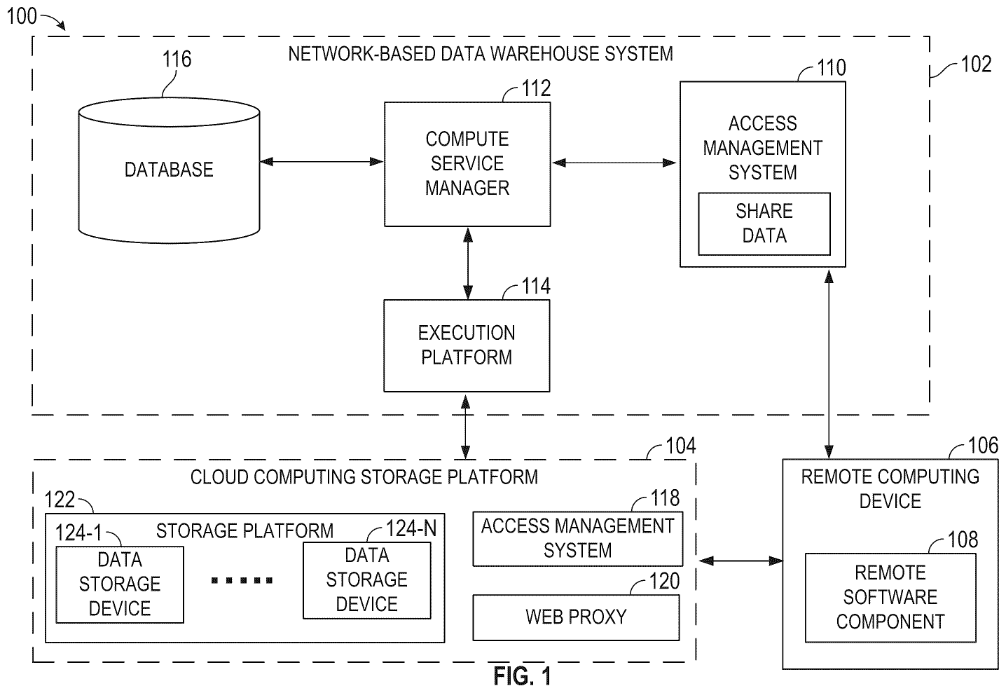

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures, such as streams on shared tables and views, as discussed in further detail below.

The network-based database system 102 comprises an access management system 110, a compute service manager 112, an execution platform (also referred to as XP) 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

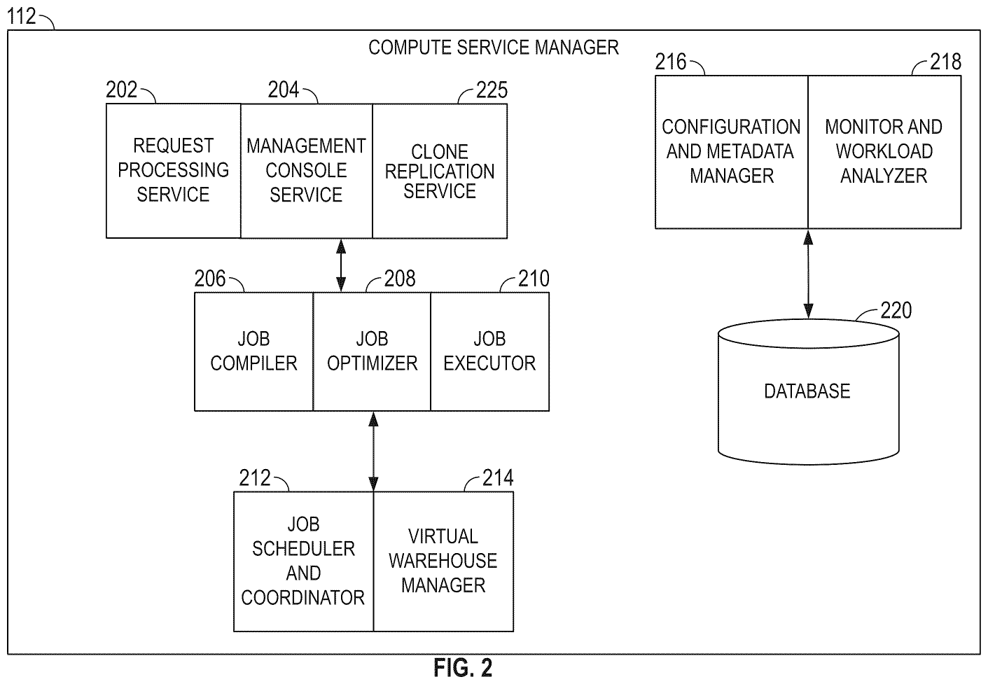

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represents any data storage device within the network-based database system 102. For example, data storage device 220 may represent caches in execution platform 114, storage devices in cloud computing storage platform 104, or any other storage device.

The compute service manager 112 further includes a clone replication service 225, which manages replication of cloned objects, as described in further detail below. In some examples, the clone replication service 225 is provided in primary deployments and may generate snapshots to be used for replicating data at secondary deployments. In some examples, the clone replication service 225 can be provided at secondary deployments to manage cloning of objects at the secondary deployments based on received snapshots. Logical clone replication is described in further detail below.

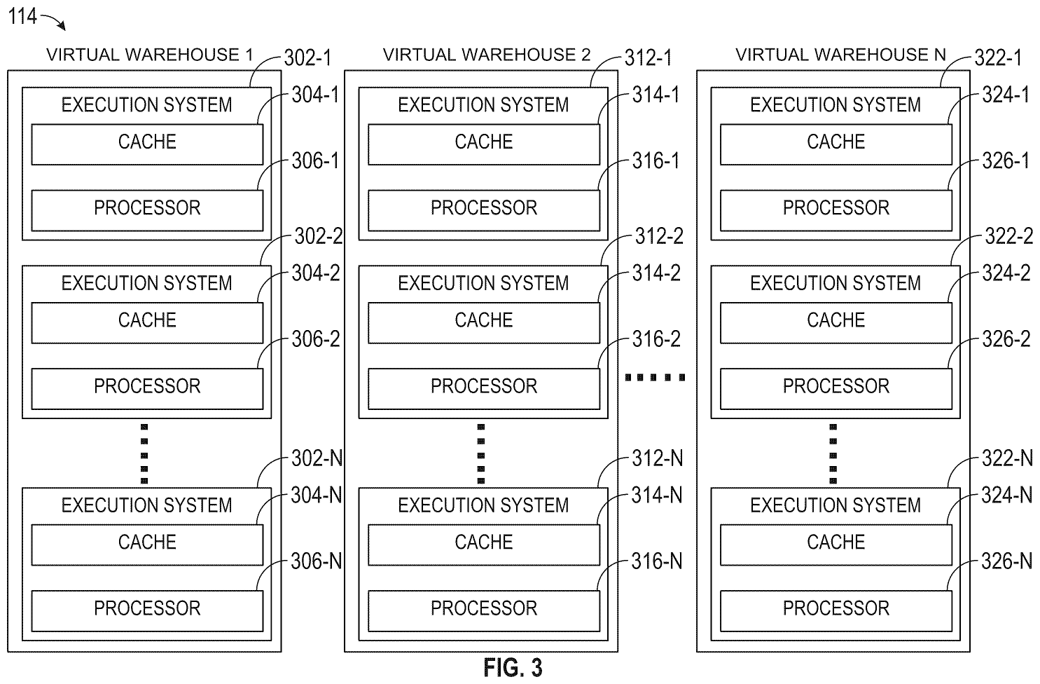

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

A table of a database may include many rows and columns of data. For example, one table may include millions of rows of data and may be very large and difficult to store or read. A very large table may be divided into multiple smaller files which may be referred to herein as “micro-partitions” or partitions. For example, one table may be divided into six distinct micro-partitions, and each of the six micro-partitions may include a portion of the data in the table. Dividing the table data into multiple micro-partitions helps to organize the data and to find where certain data is located within the table.

An analogy to the micro-partitions of the table may be different storage buildings within a storage compound. In the analogy, the storage compound is similar to the table, and each separate storage building is similar to a micro-partition. Hundreds of thousands of items are stored throughout the storage compound. Because so many items are located at the storage compound, it is necessary to organize the items across the multiple separate storage buildings. The items may be organized across the multiple separate storage buildings by any means that makes sense. For example, one storage building may store clothing, another storage building may store household goods, another storage building may store toys, and so forth. Each storage building may be labeled so that the items are easier to find. For example, if a person wants to find a stuffed bear, the person will know to go to the storage building that stores toys. The storage building that stores toys may further be organized into rows of shelving. The toy storage building may be organized so that all stuffed animals are located on one row of shelving. Therefore, the person looking for the stuffed bear may know to visit the building that stores toys and may know to visit the row that stores stuffed animals. Further to the analogy with database technology, each row of shelving in the storage building of the storage compound may be similar to a column of database data within a micro-partition of the table. The labels for each storage building and for each row of shelving are similar to metadata in a database context.

Similar to the analogy of the storage compound, the micro-partitions disclosed herein can provide considerable benefits for managing database data, finding database data, and organizing database data. Each micro-partition organizes database data into rows and columns and stores a portion of the data associated with a table. One table may have many micro-partitions. The partitioning of the database data among the many micro-partitions may be done in any manner that makes sense for that type of data. For example, if the database client is a credit card provider and the data is credit card transactions, the table may include columns such as credit card number, account member name, merchant name, date of card transaction, time of card transaction, type of goods or services purchased with card, and so forth. The table may include millions and millions of credit card transactions spanning a significant time period, and each credit card transaction may be stored in one row of the table. Because the table includes so many millions of rows, the table may be partitioned into micro-partitions. In the case of credit card transactions, it may be beneficial to split the table based on time. For example, each micro-partition may represent one day or one week of credit card transactions. It should be appreciated that the table may be partitioned into micro-partitions by any means that makes sense for the database client and for the type of data stored in the table. The micro-partitions provide significant benefits for managing the storage of the millions of rows of data in the table, and for finding certain information in the table.

A database table may store data in a plurality of micro-partitions, wherein the micro-partitions are immutable storage devices. When a transaction is executed on a such a table, all impacted micro-partitions are recreated to generate new micro-partitions that reflect the modifications of the transaction. After a transaction is fully executed, any original micro-partitions that were recreated may then be removed from the database. A new version of the table is generated after each transaction that is executed on the table. The table may undergo many versions over a time period if the data in the table undergoes many changes, such as inserts, deletes, updates, and/or merges. Each version of the table may include metadata indicating what transaction generated the table, when the transaction was ordered, when the transaction was fully executed, and how the transaction altered one or more rows in the table.

In some embodiments, all data in tables is automatically divided into an immutable storage device referred to as a micro-partition. The micro-partition may be considered a batch unit where each micro-partition has contiguous units of storage. By way of example, each micro-partition may contain between 50 MB and 500 MB of uncompressed data (note that the actual size in storage may be smaller because data may be stored compressed). Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. This granular selection process may be referred to herein as “pruning” based on metadata. Pruning involves using metadata to determine which portions of a table, including which micro-partitions or micro-partition groupings in the table, are not pertinent to a query, and then avoiding those non-pertinent micro-partitions when responding to the query and scanning only the pertinent micro-partitions to respond to the query. Metadata may be automatically gathered about all rows stored in a micro-partition, including: the range of values for each of the columns in the micro-partition; the number of distinct values; and/or additional properties used for both optimization and efficient query processing. In one embodiment, micro-partitioning may be automatically performed on all tables. For example, tables may be transparently partitioned using the ordering that occurs when the data is inserted/loaded.

In some embodiments, metadata is stored and maintained on non-mutable storage services (may be referred to herein as micro-partitions) in the cloud. These storage services may include, for example, Amazon S3®, Microsoft Azure Blob Storage®, and Google Cloud Storage®. Many of these services do not allow to update data in-place (i.e., are non-mutable or immutable). Data micro-partitions may only be added or deleted, but not updated. In some embodiments, storing and maintaining metadata on these services requires that, for every change in metadata, a metadata micro-partition is added to the storage service. These metadata micro-partitions may be periodically consolidated into larger “compacted” or consolidated metadata micro-partitions in the background.

An expression property is some information about the one or more columns stored within one or more micro-partitions. In some embodiments, the expression property includes one or more of: a summary of database data stored in a column, a type of database data stored in a column, a minimum and maximum for database data stored in a column, a null count for database data stored in a column, a distinct count for database data stored in a column, a structural or architectural indication of how data is stored, and so forth.

A cumulative expression property includes global information about data stored in a plurality of expression properties. Similar to the expression property, the cumulative expression property includes any suitable information about database data and/or the database itself. The cumulative expression property may store a summary of the information stored within the plurality of expression properties to which it is associated. In some embodiments, the cumulative expression property includes one or more of: a summary of the data stored across each of one or more micro-partitions of a table, a type of data stored in one or more columns across each of one or more micro-partitions of a table, a global minimum and maximum for data stored across each of one or more micro-partitions of a table, and so forth.

As used herein, immutable or non-mutable storage includes storage where data cannot, or is not permitted, to be overwritten or updated in-place. For example, changes to data that is located in a cell or region of storage media may be stored as a new micro-partition in a different, time-stamped, cell or region of the storage media. Mutable storage may include storage where data is or permitted to be overwritten or updated in place. For example, data in a given cell or region of the storage media can be overwritten when there are changes to the data relevant to that cell or region of the storage media.

In some embodiments, metadata is stored and maintained on non-mutable storage services in the cloud. These storage services may include, for example, Amazon S3®, Microsoft Azure Blob Storage®, and Google Cloud Storage®. Many of these services do not allow to update data in-place (i.e., are non-mutable or immutable). Data micro-partitions may only be added or deleted, but never updated. In some embodiments, storing and maintaining metadata on these services requires that, for every change in metadata, a metadata micro-partition is added to the storage service. These metadata micro-partitions may be periodically consolidated into larger “compacted” or consolidated metadata micro-partitions in the background. A metadata micro-partition version may be stored to indicate metadata micro-partitions that correspond to the compacted or consolidated version versus the pre-compaction or pre-consolidation version of metadata micro-partitions. In some embodiments, consolidation of mutable metadata in the background to create new versions of metadata micro-partitions may allow for deletions of old metadata micro-partitions and old data micro-partitions.

By using immutable storage, such as cloud storage, embodiments allow storage capacity to not have a hard limit. Using storage services in the cloud allows for virtually unlimited amounts of metadata. Reading large amounts of metadata may be much faster because metadata micro-partitions may be downloaded in parallel, including prefetching of micro-partitions. Metadata micro-partitions may also be cached on a local micro-partition system so that they are not downloaded more than once.

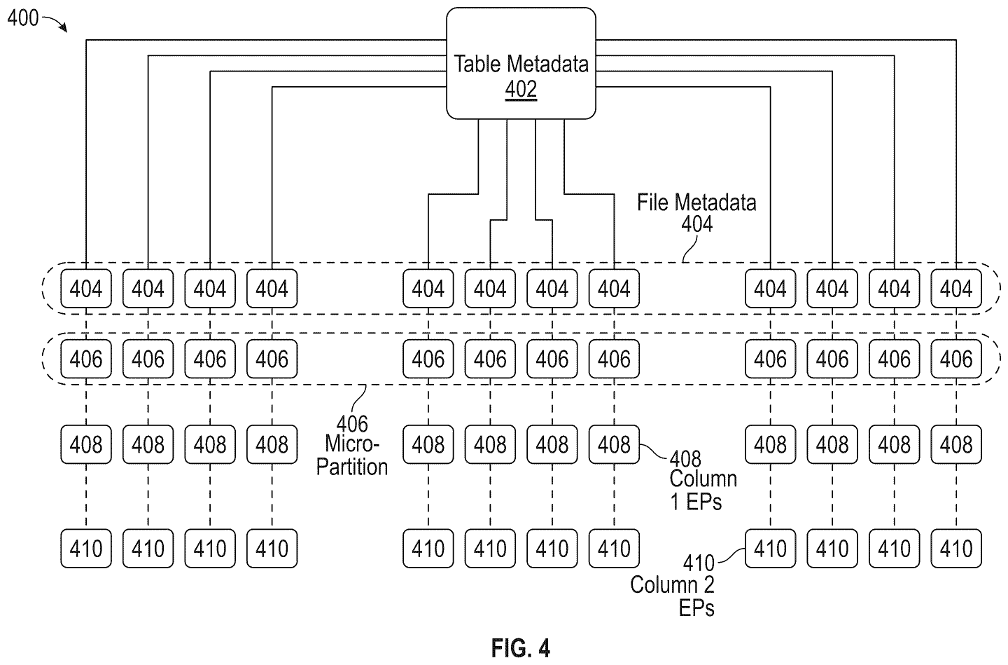

FIG. 4 is a schematic diagram of a data structure 400 for storage of database metadata, according to some example embodiments. The data structure 400 may be constructed from metadata micro-partitions, as described above, and may be stored in a metadata cache memory. The data structure 400 includes table metadata 402 pertaining to database data stored across a table of the database. The table may be composed of multiple micro-partitions serving as immutable storage devices that cannot be updated in-place. Each of the multiple micro-partitions may include numerous rows and columns making up cells of database data. The table metadata 402 may include a table identification and versioning information indicating, for example, how many versions of the table have been generated over a time period, which version of the table includes the most up-to-date information, how the table was changed over time, and so forth. A new table version may be generated each time a transaction is executed on the table, where the transaction may include a DML statement such as an insert, delete, merge, and/or update command. Each time a DML statement is executed on the table, and a new table version is generated, one or more new micro-partitions may be generated that reflect the DML statement.

The table metadata 402 includes global information about the table of a specific version. The data structure 400 further includes file metadata 404 (also referred to as micro-partition metadata) that includes metadata about a micro-partition of the table. The terms file and micro-partition may each refer to a subset of database data and may be used interchangeably in some embodiments. The file metadata 404 includes information about a micro-partition 406 of the table. The micro-partition 406 illustrated in FIG. 4 includes database data and is not part of the metadata storage. Further, metadata may be stored for each column of each micro-partition 406 of the table. The metadata pertaining to a column of a micro-partition 406 may be referred to as an expression property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition 406 of the table may include one or more expression properties. The table metadata 402 includes expression properties for column 1 of a micro-partition 406 at 408 and expression properties for column 2 of a micro-partition 406 at 410. It should be appreciated that the table may include any number of micro-partitions, and each micro-partition may include any number of columns. The micro-partitions may have the same or different columns and may have different types of columns storing different information.

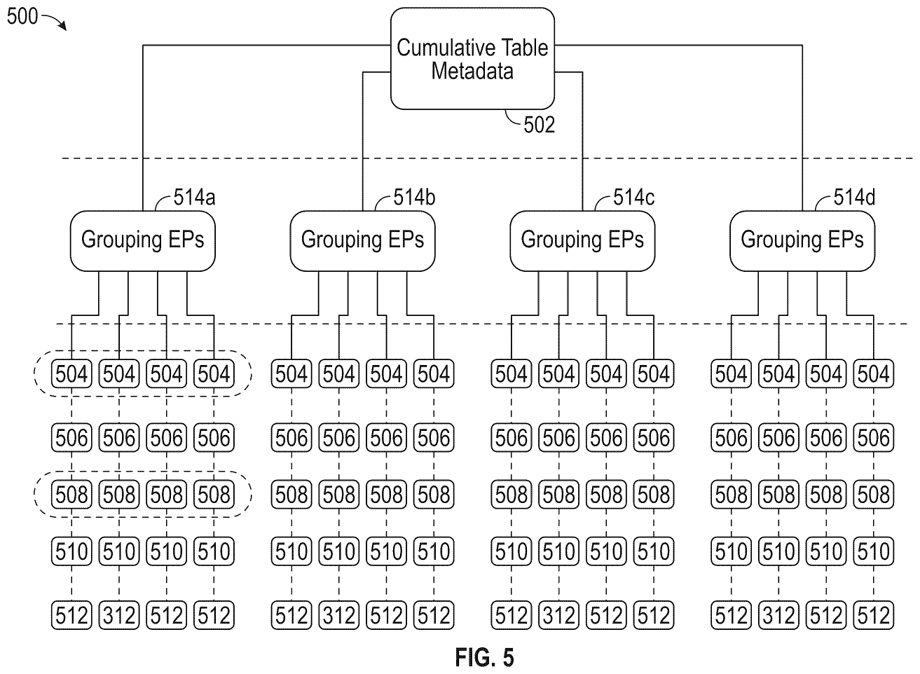

FIG. 5 is a schematic diagram of a data structure 500 for storage of database metadata, including in persistent storage and cache storage, according to some example embodiments. The data structure 500 includes cumulative table metadata 502 including information about a table of the database. The table may include a plurality of files or micro-partitions that may each include a number of columns and rows storing database data. The cumulative table metadata 502 includes global information about the table and may include summary information stored in each of a plurality of grouping expression properties 514a, 514b, 514c, and 514d (may be collectively referenced herein as “514”). The grouping expression properties 514 include aggregated micro-partition statistics, cumulative column properties, and so forth about a micro-partition 506 or a collection of micro-partitions of the table. It should be appreciated that the micro-partitions 506 illustrated in FIG. 5 may each contain a different subset of the data stored in the table and may include the same columns or may include different columns storing different types of information. The micro-partitions 506 of the table each include one or more columns and may each have the same types of columns or different types of columns. An expression property may be stored for each column of each micro-partition 506 of the table, or for a collection of micro-partitions 506 of the table as illustrated in FIG. 5. The data structure 500 includes micro-partition statistics 504 for each micro-partition 506 of the table (the micro-partition statistics 504 may alternatively be referred to herein as “micro-partition expression properties”). The micro-partition statistics 504 may include a minimum/maximum data point for the corresponding micro-partition 506, a type of data stored in the corresponding micro-partition, a micro-partition structure of the corresponding micro-partition 506, and so forth. As illustrated in FIG. 5, a column 1 expression property 508 is stored for the first column in each of the different micro-partitions 506. Further, a column 2 expression property 510 is stored for the second column in each of the different micro-partitions 506. In addition, a column 3 expression property 512 is stored for the third column in each of the different micro-partitions. It should be appreciated that each of the micro-partitions may include any suitable number of columns, and that an expression property may be stored for each of the columns, or for any suitable number of the columns, stored in each micro-partition of the table. The column 1 expression properties 508, the column 2 expression properties 510, and the column 3 expression properties 512, along with any additional column expression properties that may be included as deemed appropriate, may be stored as part of a metadata micro-partition. A metadata micro-partition may be persisted in immutable storage and the grouping expression properties 514 may also be stored within a metadata micro-partition in immutable storage. A metadata manager may maintain all metadata micro-partitions, including metadata micro-partitions comprising the grouping expression properties 514, and micro-partition statistics 504, and/or the column expression properties 508-512.

The cumulative table metadata 502 includes global information about all micro-partitions within the applicable table. For example, the cumulative table metadata 502 may include a global minimum and global maximum for the entire table, which may include millions or even hundreds of millions of micro-partitions. The cumulative table metadata 502 may include any suitable information about the data stored in the table, including, for example, minimum/maximum values, null count, a summary of the database data collectively stored across the table, a type of data stored across the table, a distinct for the data stored in the table, and so forth.

The grouping expression properties 514a-514d include information about database data stored in an associated grouping of micro-partitions. For example, an example grouping expression property is associated with micro-partitions numbered 3040 thru 3090 such that the example grouping expression property is associated with fifty different micro-partitions. The example grouping expression property includes information about those fifty different micro-partitions. A grouping expression property 514 may include any suitable information about the micro-partitions with which it is associated. For example, a grouping expression property 514 may include a global minimum/maximum for the collective set of micro-partitions, a minimum/maximum for each of the micro-partitions within the grouping, a global null count, a null count for each of the micro-partitions within the grouping, a global summary of data collectively stored across the grouping of micro-partitions, a summary of data stored in each of the micro-partitions in the grouping, and so forth. The global expression property 514 may include global information for all micro-partitions within the grouping of micro-partitions that is associated with the grouping expression property 514, and it may further include information specific to each of the micro-partitions within the associated grouping.

The metadata structure disclosed in FIG. 5 provides increased granularity in cumulative table metadata 502. The grouping expression properties 514 provide valuable global metadata pertaining to a collection of micro-partitions 506 of the database. Further, each of the columnar expression properties 508, 510, 512 provide valuable information about a column of a micro-partition 506 of the table.

The metadata structures disclosed herein, including the data structure 500 shown in FIG. 5, increases efficiency when responding to database queries. A database query may request any collection of data from the database and may be used for creating advanced analyses and metrics about the database data. Some queries, particularly for a very large database, can be extremely costly to run both in time and computing resources. When it is necessary to scan metadata and/or database data for each file or micro-partition of each table of a database, it can take many minutes or even hours to respond to a query. In certain implementations, this may not be an acceptable use of computing resources. The data structure 500 disclosed herein provides increased metadata granularity and enables multi-level pruning of database data. During compilation and optimization of a query on the database, a processor may scan the cumulative table metadata 502 to determine if the table includes information pertaining to the query. In response to determining, based on the cumulative table metadata 502, that the table includes information pertaining to the query, the processor may scan each of the grouping expression properties 514 to determine which grouping of micro-partitions of the table include information pertaining to the query. In response to determining, based on a first cumulative expression property, that a first grouping of micro-partitions does not include information pertaining to the query, the processor may discontinue database scanning of that first grouping of micro-partitions. In response to determining, based on a second cumulative expression property, that a second grouping of micro-partitions includes information pertaining to the query, the processor may proceed to scan expression properties for that second grouping of micro-partitions. The processor may efficiently determine which micro-partitions include pertinent data and which columns of which micro-partitions include pertinent data. The processor may proceed to scan only the relevant column(s) and micro-partition(s) that include information relevant to a database query. This provides a cost-efficient means for responding to a database query by way of multi-level pruning based on multi-level table metadata.

Further to increase the cost efficiency of database queries, a compute service manager may store the cumulative table metadata 502 in a cache for faster retrieval. Metadata for the database may be stored in a metadata store separate and independent of a plurality of shared storage devices collectively storing database data. In a different embodiment, metadata for the database may be stored within the plurality of shared storage devices collectively storing database data. In various embodiments, metadata may be stored in metadata-specific micro-partitions that do not include database data, and/or may be stored within micro-partitions that also include database data. The metadata may be stored across disk storage, such as the plurality of shared storage devices, and it may also be stored in cache within the compute service manager.

Table sizes have been growing; some tables can include thousands or hundreds of thousands of columns. Also, automated operations can create large tables on a frequent basis (e.g., every hour). For example, users can create clones of tables for a variety of reasons. Moreover, the network-based data system described above can be provided across different deployments. For example, deployments may be distributed across different regions, cloud service providers, etc.

A deployment may include multiple components such as a metadata store/DB, a front-end layer, a load balancing layer, a data warehouse, etc., as discussed above with respect to FIGS. 1-3. The deployments may be provided as public or private deployments. A public deployment may be implemented as a multi-tenant environment, where each tenant or account shares processing and/or storage resources. For example, in a public deployment, multiple accounts may share a metadata store, a front-end layer, a load balancing layer, a data warehouse, etc. A private deployment, on the other hand, may be implemented as a dedicated, isolated environment, where processing and/or storage resources may be dedicated.

Some customers may employ a first deployment as a primary deployment and may store replicated data from the primary deployment in a secondary deployment as a backup for different reasons, such as disaster recovery. Data from the primary deployment may be periodically replicated at the secondary deployment. For example, if a system failure occurs at the primary deployment, the customer can begin using the secondary deployment as its new primary deployment.

However, replicating data in different storage locations can significantly increase storage costs. The costs can especially increase when multiple cloned tables are generated for a table. In some conventional systems, the cloned tables are simply physically replicated in the secondary deployment, increasing data transfer during replication and increasing storage costs on the secondary deployment. Next, techniques for efficient replication of cloned data objects, such as tables, are described.

Data sets stored in the network-based data system can become quite large. As mentioned above, the data sets, such as tables, can be stored and maintained in micro-partitions (also referred to as a partition). For example, data in a table may automatically be divided into an immutable storage device referred to as a micro-partition. A micro-partition may be an immutable storage device in a database table that cannot be updated in-place and must be regenerated when the data stored therein is modified. A micro-partition may be considered a batch unit where each micro-partition has contiguous units of storage. By way of example, each micro-partition may contain between 50 MB and 500 MB of uncompressed data (note that the actual size in storage may be smaller because data may be stored compressed).

Groups of rows in tables may be mapped into individual micro-partitions organized in a columnar fashion. This size and structure allow for extremely granular selection of the micro-partitions to be scanned, which can be comprised of millions, or even hundreds of millions, of micro-partitions. Metadata may be automatically gathered about all rows stored in a micro-partition, including: the range of values for each of the columns in the micro-partition; the number of distinct values; and/or additional properties, as described herein.

In some embodiments, micro-partitioning may be automatically performed on all tables. For example, tables may be transparently partitioned using the ordering that occurs when the data is inserted/loaded. When new data is written, a new micro-partition is created and replaces an older micro-partition. Background file deleting operations can be performed to delete older micro-partitions that have been replaced. However, it should be appreciated that this disclosure of the micro-partition is exemplary only and should be considered non-limiting. It should be appreciated that the micro-partition may include other database storage devices without departing from the scope of the disclosure.

The metadata may include table properties, statistics (stats), and other information. The metadata may include expression properties (EP) of tables and partitions of tables. For example, EP files for tables/partitions can include the range of values for each of the columns in the partition/table (e.g., min/max values); the number of distinct values (NDV); null count, and/or additional properties used for operations, such as optimization and efficient query processing.

Instead of physically copying all cloned tables, logical representation of the clone tables in the secondary deployment can be used to reduce data transfer and storage costs. In response to a refresh request, the data system may clone from existing tables stored in the secondary deployment by applying a difference operation on the existing tables instead of copying entire cloned tables every time. Partition files (files including data in micro-partitions) can be further deduped through copy service used in the replication process to further reduce data transfer and storage resources.

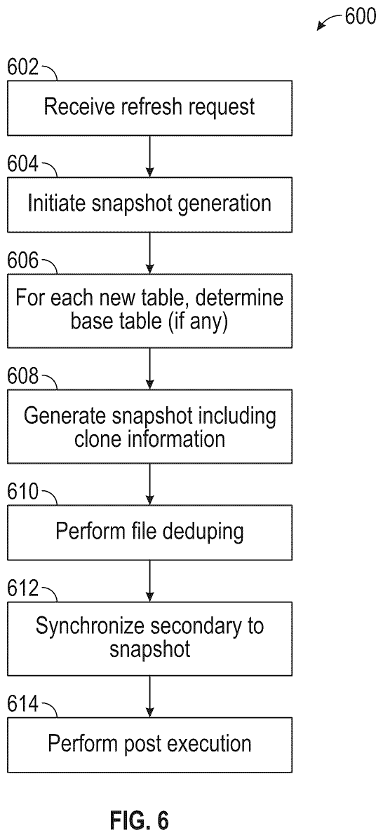

FIG. 6 is a flow diagram of method 600 for replicating cloned tables in a network-based data system, according to some example embodiments. Method 600 may be executed by different deployments in the network-based data system, such as a primary deployment and a secondary deployment described herein. At operation 602, a refresh request (e.g., “ALTER DATABASE REFESH”) is received. For example, a primary deployment may receive a refresh command to backup data to a secondary deployment. The refresh command may be automatically executed periodically at set times (e.g., every 1 minute, 5 minutes, 1 hour, etc).

At operation 604, in response to the refresh command, the primary deployment initiates generation of a snapshot of what has been changed since the last refresh request.

At operation 606, for each new table since the last refresh, the primary deployment determines whether a base table can be used as a reference table, indicating that the new table is a cloned table version of a previous table.

In some examples, the system may determine the base table for a cloned table using a property of the cloned table, e.g., “cloneFromID” or “cloneFromTable.” If such a property (e.g., cloneFromTable) does not exist in the snapshot or the table is not a clone, the system treats the table as a new clone set. If the base table (“cloneFromTable”) exists in secondary inventory and is also in the snapshot (not dropped), the system uses the identified table as the base table (i.e., reference table). If cloneFromTable is also a new table in the snapshot, the system goes through the chain until the system finds the cloneset base table. At the end of operation 606, the system may separate new tables since the last refresh into two cases. Case A includes tables with a base table, and Case B includes tables without a base table.

At operation 608, the snapshot is generated with relevant cloning information.

For Case A (new tables with an identified base table): If the base table is within the same snapshot or already saved on the secondary side, the system may determine the inventory of the base table on the secondary side. The inventory includes an inventory of partition files. The plan is to clone base table on secondary so the primary deployment may only send the difference (diff) between the secondary base table inventory and the new table.

For Case B (new tables without a base table): These tables are created on the secondary deployment as a new cloneset (i.e., possibly a future base table). The system may perform a compaction on each table in the primary deployment similar to how clones are generated. The system may write the compacted EP files into the snapshot. Note that similar to table cloning, the system may not be compacting the tables in primary deployment, the system is only writing the compacted results into the snapshot.

At operation 610, partition file deduping in the snapshot is performed. The deduping can be performed through a copy service function. For example, same partition file may be needed in different tables in the same refresh request. The system can therefore identify the duplication and transmit the file only once. The system may use a point lookup. The system can present one entry per partition file and may also persist values like shortnames, fileID, uniqueFileId in copy service to make sure different tables using the same files are identified.

For example, consider that new tables T2 and T3 have been added since the last refresh and both are clones of T1 (directly or indirectly). T1 includes partition file f1. T2 includes additional partition files f2 and f3 as compared to T1. T3 includes additional partition files f2 and f4 as compared to T1. Since both T2 and T3 share new file f2, f2 can be sent just once reducing data transfer resources. Tables T2 and T3 may share file f2 on the secondary side.

At operation 612, the secondary deployment synchronizes to the snapshot, which is transmitted from the primary deployment to the secondary deployment. Logic for tables that already exist in secondary stay the same. The system may create new tables for base tables (both case A and case B) before creating other tables. This is to make sure that the system can find the base table when populating cloneFromId/sourceId and source ids for table columns.

For case A: Consider an example where T1 is identified as a base table for new table T2. The system may get all compacted EP plus delta EP from local root table T1 (base table) at last refresh time. The system may add diff values from primary as delta EP (after transforming them). The system may use the same logic in cloning and compact the EP files and create the new table T2. T2 is a collection of T1 plus additional delta EP files. The target should just be newly created T2.

For case B: The system may transform compacted EP files from the primary deployment and persist them in the secondary deployment. Note that similar to the primary side, the system may use an in-memory mapping for EP files so the system can only persist the physical EP files once for the same primary EP files.

At operation 612, the secondary deployment performs post execution operations. To be able to write compacted EP files, the system may persist the new EP file version (epFile Version) as CLONING. The system creates epFile Version when creating new tables in replication. One change is to persist as CLONING instead of ACTIVE then write compacted EP plus delta EP files in this epFile Version. In post-commit, the system switches epFile Version to active and persist the new table versions needed.

If the replication fails, the system can delete the table in post-commit. This can be used because the logic above relies on the tables being newly created. The system may rollback created tables to make sure the next run would correctly share partition files. This can be done by adding new tables in a job journal.

For new tables with base tables, the system achieves EP file sharing through cloning in the secondary deployment. For a new cloneset, this is achieved by running cloning logic in the primary deployment and maintain the same existing EP file sharing.

In some example embodiments, instead of using the cloneFrom table as the base table, the system can use a different table in the cloneset. This technique can reduce how many files are shared. In some examples, the table with most overlap with the new table may be identified from the clonest, for example using EP values.

As mentioned above, the base table may not be in the current snapshot, but was previously replicated, so the base table may be stored in the secondary inventory. In some cases, the cloneFrom table may be a dropped table. The system may determine the inventory for the dropped table. The system may get different table versions and perform a diff operation from an active table if the dropped table is still in data retention time. The system can also request the secondary side to send the full inventory. This may use an additional message round trip.

Diff calculation may be performed using different techniques. Different techniques can be selected based on different cases or scenarios. Let's consider an example: the system calculates diff for (T1, tv1) and (T2, tv2). Here T1 is the base table and T2 is a cloned table. tv2 is the most recent committed table version.

One diff technique is an incremental technique. Let's consider tv1 is still within the data retention time period. The system retrieves compacted EPs+delta EPs at tv1 and tv2 and directly compares EP files between tv1 and tv2. Due to clone table EP sharing, the system can dedupe EP files without loading them.

One optimization technique is to start persisting cloneFrom table versions. Consider another example: for cloneFrom table version tv3, there are a few cases: tv1<=tv3<=tv2. Then the diff may be (all delta EPs between tv1 and tv3 from T1)+(delta EPs between tv3 and tv2 from T2). tv3<tv1<=tv2 (reparent or clone from time travel). The diff can be the (reverse of all delta EPs between tv3 and tv1 from T1)+(delta EPs between tv3 and tv2 from T2). If tv3 is out of data retention, the system can fall back to the case without optimization.

Another diff technique is a full inventory technique. Here, instead of tv1, secondary deployment sends a full inventory with full inventory of references to partition files and the system loads all files in memory and performs a set diff. Secondary deployment sends unique global file references of the files it has, and then the primary deployment compares the global references against its files and sends the difference across to secondary deployment.

Another diff technique is an incremental fallback technique. Let's consider tv1 is out of data retention. The system adds partition files in T2 that are created after tv1. The system sends the inventory of all files created before tv2 by comparing the dml start times of all the files that belong to the available version as activeLowerFiles. In the secondary deployment, the system finds existing inventories in T1 at tv1 and also deletes inventories that are not in the activeLowerFiles. Note that the deletion is on T2.

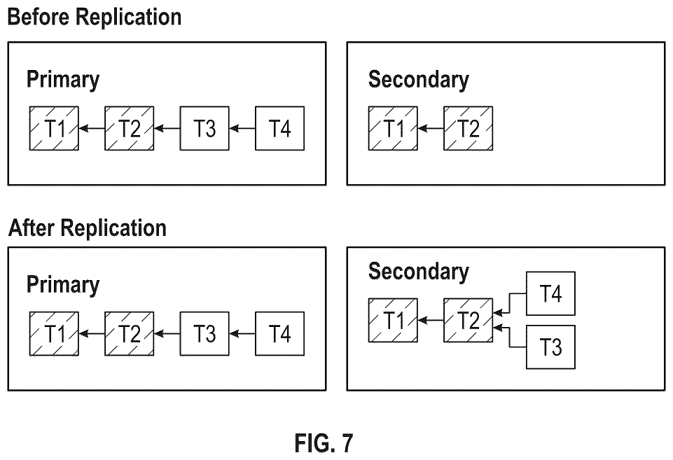

FIG. 7 shows an example of clone replication, according to some example embodiments. Before replication, the primary side includes tables T1-T4. The arrow represents the clone from the base table. That is, T2 is a clone from T1, T3 is a clone from T2, and T4 is a clone from T3. Based on the last refresh, the secondary side includes Tl and T2. T3 and T4 have been added since the last refresh. In replication, the system checks existing tables in the snapshot to find the first table already existing in the secondary. The cloned tables in secondary for T3 and T4 therefore will both point to T2.

In the secondary, the system treats all new tables as a clone from the base table, which in this case is T2. The sourceId/cloneGroupID for T3 and T4 is set to be the same as T2 so T1-T4 in the secondary are still in the same clone set. For T3 and T4, if a file already exists in T2 in the secondary, the system can reuse that file. For T2, T3, and T4, if a file is needed for multiple tables in the replication, the system can only send the file once and persist it once in the secondary as part of partition file deduping, as described above.

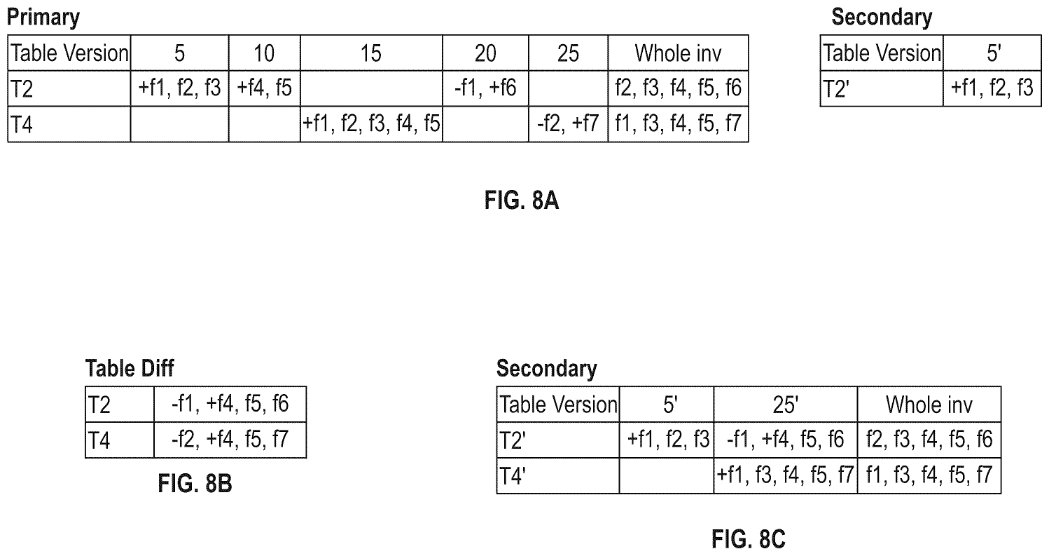

FIGS. 8A-8C show another example of clone replication, according to some example embodiments. In FIG. 8A, T4 was created as a clone of T2 at tableversion (tv) 15. Last replication, in this example, was performed before tv10. Table diff for T2 at replication is calculated using T2 at tv5. However, table diff for T4 is instead calculated as diff between T4 whole inv with secondary T2′ inventory.

FIG. 8B shows the table diff for tables T2 and T4. Note that here f4 and f5 are needed by both tables T2 and T4, so the system may only send them once by leveraging copy service deduping as described above.

FIG. 8C shows the secondary side after replication. After applying the diffs, T4 is provided as a merge of (T2′ at 5′) plus (table diff).

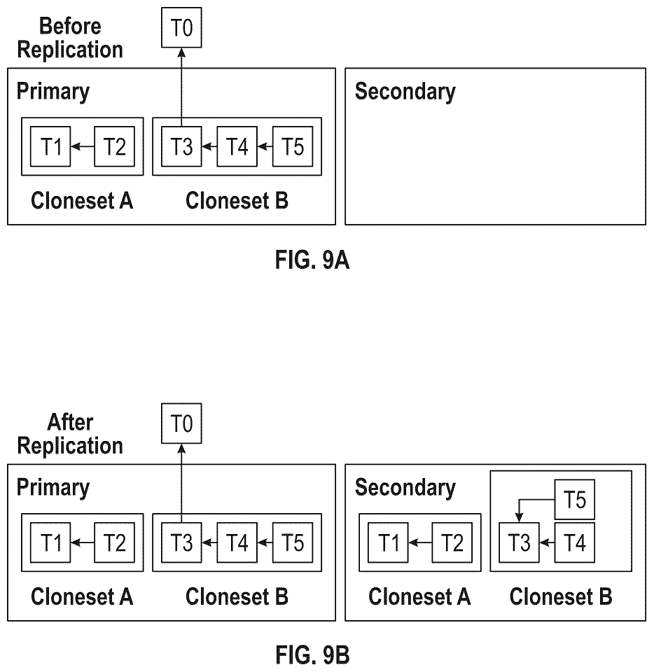

For tables that the system cannot find clones from base/source tables, the system may group by source id (e.g., clone set id). FIGS. 9A-9B show another example of clone replication, according to some example embodiments. FIG. 9A shows before replication. In this example, Cloneset A has tables T1 and T2 where T2 is a clone from T1. Cloneset B includes T3, T4, T5, where T4 is a clone from T3 and T5 is a clone from T4. However, T3 is a clone from T0, which can no longer be found. For example, T0 may have been deleted or dropped from the primary side. At this time, none of the tables depicted have been replicated on the secondary side.

FIG. 9B shows after replication. The system creates corresponding clonesets in the secondary. The clone from table will be a source table for newly created clonesets in secondary. All tables in the cloneset will directly point to clone from table for simplicity. Here, T4 and T5 point to T3 for simplicity. Partition files will be shared within the cloneset.

In some example embodiments, clone replication atomicity may be maintained. In clone replication, the system can write compacted EP files during replication for newly created clone tables. To make sure the entire replication process is atomic (e.g., users cannot see intermediate steps), the system can create an invisible table and then make the table visible in job commit. The system can persist the cloned table on the secondary side as invisible initially. That is, while the secondary side is performing the cloning operation and the table diff operations, the table is made invisible. After the operations are performed, the secondary side can make the table visible during job commit.

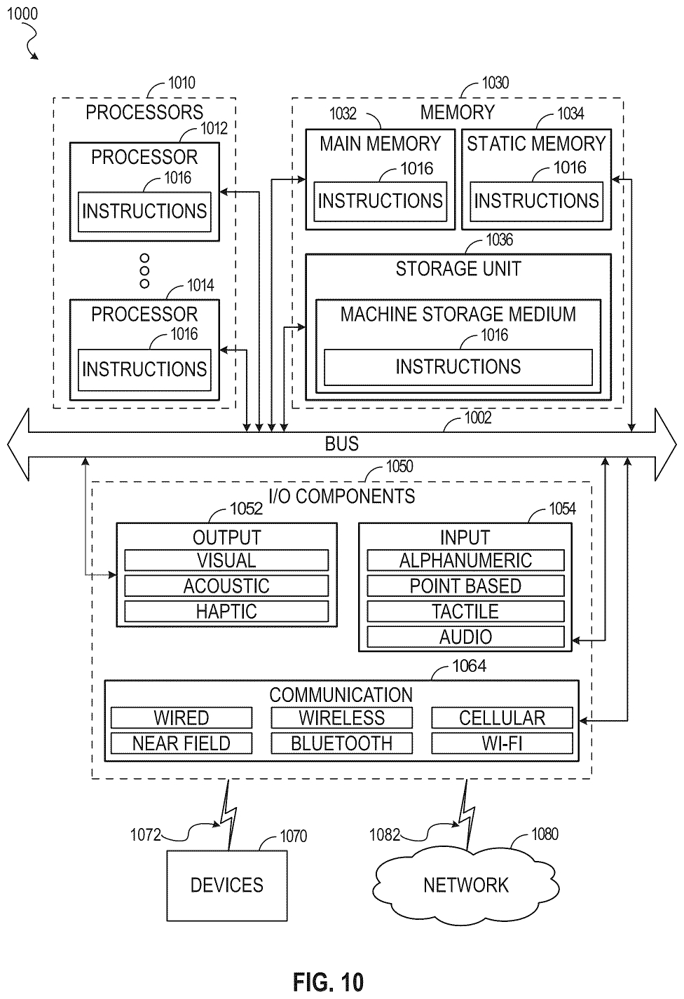

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute any one or more operations of any one or more of the methods described herein. As another example, the instructions 1016 may cause the machine 1000 to implement portions of the data flows described herein. In this way, the instructions 1016 transform a general, non-programmed machine into a particular machine 1000 (e.g., the remote computing device 106, the access management system 110, the compute service manager 112, the execution platform 114, the access management system 118, the Web proxy 120) that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 includes processors 1010, memory 1030, and input/output (I/O) components 1050 configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions 1016 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, and other communication components to provide communication via other modalities. The devices 1070 may be another machine or any of a wide variety of peripheral devices (e.g., a peripheral device coupled via a universal serial bus (USB)). For example, as noted above, the machine 1000 may correspond to any one of the remote computing device 106, the access management system 118, the compute service manager 112, the execution platform 114, the Web proxy 120, and the devices 1070 may include any other of these systems and devices.

The various memories (e.g., 1030, 1032, 1034, and/or memory of the processor(s) 1010 and/or the storage unit 1036) may store one or more sets of instructions 1016 and data structures (e.g., software) embodying or utilized by any one or more of the methodologies or functions described herein. These instructions 1016, when executed by the processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving, at a primary deployment of a network-based data system, a refresh request to replicate data from the primary deployment to a secondary deployment; identifying a first table created in the primary deployment since a previous refresh request; determining that the first table is a cloned table version of a second table; performing a difference operation on the first table and an inventory of the second table; generating a snapshot in response to the refresh request, the snapshot comprising information to clone the first table in the secondary deployment from the second table in the secondary deployment; and transmitting the snapshot to the secondary deployment.

Example 2. The method of example 1, wherein the information comprises delta expression property files based on the inventory of expression property files of the second table and the first table.

Example 3. The method of any of examples 1-2, further comprising: determining that the second table is stored in the secondary deployment from the previous refresh, wherein the inventory of the second table is retrieved from the previous refresh.

Example 4. The method of any of examples 1-3, further comprising: determining that the second table is also created since the previous refresh, wherein the snapshot includes information to create the second table in the secondary deployment before creating a cloned first table.

Example 5. The method of any of examples 1-4, wherein the first table comprises a plurality of partitions.

Example 6. The method of any of examples 1-5, further comprising: deduping partition files in the snapshot, wherein deduped partition files are to be shared by a plurality of tables in the secondary deployment.

Example 7. The method of any of examples 1-6, wherein the primary deployment and secondary deployment are provided by different cloud service providers.

Example 8. The method of any of examples 1-7, wherein determining that the first table is the cloned table version of the second table is based on a table property of the first table.

Example 9. A system comprising: one or more processors of a machine; and a memory storing instructions that, when executed by the one or more processors, cause the machine to perform operations implementing any one of example methods 1 to 8.

Example 10. A machine-readable storage device embodying instructions that, when executed by a machine, cause the machine to perform operations implementing any one of example methods 1 to 8.

What is claimed is:

1. A method comprising:
receiving, at a primary deployment of a network-based data system, a refresh request to replicate data from the primary deployment to a secondary deployment;
identifying a first table created in the primary deployment since a previous refresh request;
determining that the first table is a cloned table version of a second table;
performing a difference operation on the first table and an inventory of the second table;
generating a snapshot in response to the refresh request, the snapshot comprising information to clone the first table in the secondary deployment from the second table in the secondary deployment; and
transmitting the snapshot to the secondary deployment.

2. The method of claim 1, wherein the information comprises delta expression property files based on the inventory of expression property files of the second table and the first table.

3. The method of claim 1, further comprising:
determining that the second table is stored in the secondary deployment from the previous refresh, wherein the inventory of the second table is retrieved from the previous refresh.

4. The method of claim 1, further comprising:
determining that the second table is also created since the previous refresh, wherein the snapshot includes information to create the second table in the secondary deployment before creating a cloned first table.

5. The method of claim 1, wherein the first table comprises a plurality of partitions.

6. The method of claim 5, further comprising:
deduping partition files in the snapshot, wherein deduped partition files are to be shared by a plurality of tables in the secondary deployment.

7. The method of claim 1, wherein the primary deployment and secondary deployment are provided by different cloud service providers.

8. The method of claim 1, wherein determining that the first table is the cloned table version of the second table is based on a table property of the first table.

9. A machine-storage medium embodying instructions that, when executed by a machine, cause the machine to perform operations comprising:
receiving, at a primary deployment of a network-based data system, a refresh request to replicate data from the primary deployment to a secondary deployment;
identifying a first table created in the primary deployment since a previous refresh request;
determining that the first table is a cloned table version of a second table;
performing a difference operation on the first table and an inventory of the second table;
generating a snapshot in response to the refresh request, the snapshot comprising information to clone the first table in the secondary deployment from the second table in the secondary deployment; and
transmitting the snapshot to the secondary deployment.

10. The machine-storage medium of claim 9, wherein the information comprises delta expression property files based on the inventory of expression property files of the second table and the first table.

11. The machine-storage medium of claim 9, further comprising:
determining that the second table is stored in the secondary deployment from the previous refresh, wherein the inventory of the second table is retrieved from the previous refresh.

12. The machine-storage medium of claim 9, further comprising:
determining that the second table is also created since the previous refresh, wherein the snapshot includes information to create the second table in the secondary deployment before creating a cloned first table.

13. The machine-storage medium of claim 9, wherein the first table comprises a plurality of partitions.

14. The machine-storage medium of claim 13, further comprising:
deduping partition files in the snapshot, wherein deduped partition files are to be shared by a plurality of tables in the secondary deployment.

15. The machine-storage medium of claim 9, wherein the primary deployment and secondary deployment are provided by different cloud service providers.

16. The machine-storage medium of claim 9, wherein determining that the first table is the cloned table version of the second table is based on a table property of the first table.

17. A system comprising:
at least one hardware processor; and
at least one memory storing instructions that, when executed by the at least one hardware processor, cause the at least one hardware processor to perform operations comprising:
receiving, at a primary deployment of a network-based data system, a refresh request to replicate data from the primary deployment to a secondary deployment;
identifying a first table created in the primary deployment since a previous refresh request;
determining that the first table is a cloned table version of a second table;
performing a difference operation on the first table and an inventory of the second table;
generating a snapshot in response to the refresh request, the snapshot comprising information to clone the first table in the secondary deployment from the second table in the secondary deployment; and
transmitting the snapshot to the secondary deployment.

18. The system of claim 17, wherein the information comprises delta expression property files based on the inventory of expression property files of the second table and the first table.

19. The system of claim 17, the operations further comprising:
determining that the second table is stored in the secondary deployment from the previous refresh, wherein the inventory of the second table is retrieved from the previous refresh.

20. The system of claim 17, the operations further comprising:
determining that the second table is also created since the previous refresh, wherein the snapshot includes information to create the second table in the secondary deployment before creating a cloned first table.

21. The system of claim 17, wherein the first table comprises a plurality of partitions.

22. The system of claim 21, the operations further comprising:
deduping partition files in the snapshot, wherein deduped partition files are to be shared by a plurality of tables in the secondary deployment.

23. The system of claim 17, wherein the primary deployment and secondary deployment are provided by different cloud service providers.

24. The system of claim 17, wherein determining that the first table is the cloned table version of the second table is based on a table property of the first table.
